(19) United States
(12) Patent Application Publication
(10) Pub. No.: US 2013/0243638 A1
(43) Pub. Date: Sep. 19, 2013

(54) Magnetic Material And A Method For Producing Same

(71) Applicant: KSB AKTIENGESELLSCHAFT, Frankenthal (DE)

(72) Inventor: Dirk Ingmar Uhlenhaut, Zuerich (CH)

(73) Assignee: KSB Aktiengesellschaft, Frankenthal (DE)

(21) Appl. No.: 13/891,058

(22) Filed: May 9, 2013

Related U.S. Application Data
(63) Continuation of application No. PCT/EP2011/069201, filed on Nov. 2, 2011.

(30) Foreign Application Priority Data
Nov. 10, 2010 (DE) 10 2010 043 704.2

(51) Int. Cl. H01F 1/01; H01F 41/00

(52) U.S. Cl. CPC H01F 1/01; H01F 41/00
USPC 419/32; 75/228

(57) ABSTRACT

A magnetic material is provided, the magnetic material including a powder composite material sintered from at least one magnetizable alloy powder of a high energy density, and fibers admixed with the powder composite. The fibers may be aligned in one direction to improve at least one of high-melting, high-modulus and high-strength material properties.

### CROSS REFERENCE TO RELATED APPLICATIONS

This application is a continuation of PCT International Application No. PCT/EP2011/069201, filed Nov. 2, 2011, which claims priority under 35 U.S.C. §119 from German Patent Application No. 10 2010 043 704.2, filed Nov. 10, 2010, the entire disclosures of which are herein expressly incorporated by reference.

### BACKGROUND AND SUMMARY OF THE INVENTION

The invention relates to a magnetic material consisting of a powder composite material, sintered from at least one magnetizable alloy powder and a method for producing same.

Magnetic materials are known in various embodiments. Currently used magnetic materials achieve energy densities of about 200-450 kJ/m³, the energy densities in magnetic materials conventionally being indicated as the product (BH)max of coercive field strength H_{C} and remanence BR of the magnetic material in kJ/m³. Almost exclusively samarium-cobalt, typically Co₁₇Sm₂, and iron-neodymium-boron, typically Fe₁₄Nd₂B, are used. The magnets are produced as sintered bodies of intermetallic phases, and they are therefore distinguished by very low strength under tension; for example, the tensile strength of iron-neodymium-boron is about 78.5 MPa. Mechanical postprocessing is very elaborate. Likewise, the stability under extreme conditions is very restricted, and the materials are thus often very susceptible to corrosion.

German patent document no. DE 26 18 425 A1 describes a production method for a magnetic material, which consists of two different phases, in which case a first phase may be ductile. Owing to the interfaces formed between the ductile phase and the brittle phase, the material overall obtains ductile properties. A disadvantage, however, is that the production of the material must follow very accurate constraints, and that the resulting composite does not have a high strength.

German patent document no. DE 10 2005 003 247 B4 describes a magnetic material which is plastic-bound. Production is carried out by means of two steps, magnetic powder and plastic binder being mixed and compressed in the first step, and the plastic being cured in the second step. Production of this magnetic material in a plurality of steps is, however, time-consuming and results in a mechanically soft and not very strong magnet with a low energy density.

It is an object of the invention to provide a magnetic material of the type mentioned in the introduction, which is mechanically stable and can be produced straightforwardly and economically.

According to the solution to this object, fibers, platelets or so-called whiskers are admixed with the alloy powder which constitutes the magnetic material. Whiskers are intended to mean needle-shaped single crystals having a diameter of a few micrometers and a length of up to several hundred micrometers. Owing to the fibers, the alloy powder composite contains long-scale elements, which permits distribution of tensile forces within the entire magnet. The strength of the magnet is therefore increased and fractures are avoided. The proportion of the fibers in the mixture is to be selected in such a way that, on the one hand, the desired strength is achieved and, on the other hand, the energy density of the material remains at a high level. The fiber proportion can be optimized as a function of the application. Production of a fiber-reinforced magnetic material according to the invention takes place in one step, economically and with a high cycle rate.

In order to produce the magnetic material, it is particularly advantageous for the alloy powder to contain rare earth components. The energy density, i.e. the product (BH)ₘₐₓ of coercive field strength H_{C} and remanence B_{R}, of the magnetic material is greatly increased by the use of a suitable mixture of rare earths, and reaches values of between 200 and 450 kJ/m³.

In order to avoid influencing the magnetic properties of the magnetic material, it is advantageous for the fibers to consist of magnetically inactive material. To this end, various organic, semimetallic, metallic and ceramic fibers may be used, the influence of which on the resulting magnetic field of the material is vanishingly small.

As an alternative, however, the magnetic properties of the material may be influenced by magnetically active fibers in such a way that the magnetic field of the material is strengthened in a defined direction.

According to the invention, a method for producing a magnetic material is described, in which the fibers are mixed with the alloy powder and the magnet is produced from this mixture. It is advantageous for homogeneous mixing of the alloy powder and fibers to be achieved before the magnet is produced, for example by sintering. Mixing of the components is essential in order to achieve homogeneous material properties, in particular magnetic and mechanical properties.

In a particular configuration of the invention, the fibers are aligned in one direction. Owing to this anisotropy, it is possible to achieve mechanical properties which ensure improved stability in the privileged direction. In the case of fibers which influence the magnetic properties of the magnetic material, the latter may be strengthened by aligning the fibers in the privileged direction. Alignment of the fibers is achieved by feeding the mixture of fibers and alloy powder into the mold with a defined speed. The fibers become aligned during the flow. As an alternative, the fibers may be introduced into a sintering mold in an aligned form, the mold then subsequently being filled with the alloy powder. To this end, it is essential that the alloy powder can fully fill the space between the fibers. Fiber structures, for example fabrics or knits or nonwovens, may be filled with alloy powder and sintered to form the magnetic material. The orientation in these fiber structures may be configured according to the mechanical and magnetic requirements.

As an alternative, the fibers are distributed isotropically in the magnetic material. In this way, no spatial direction is specially privileged, and the magnetic material can thus be used independently of direction. To this end, it is possible to excite the fibers and the alloy powder using ultrasound, so that non-orientated excitation and therefore an isotropic distribution of the fibers are achieved.

Other embodiments derive from combination of those presented above, and are therefore not further mentioned here.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A magnetic material, comprising:
a powder composite material sintered from at least one magnetizable alloy powder; and
fibers admixed in the powder composite material;
wherein the fibers are aligned in one direction such that in the one direction at least one of a mechanical stability of the magnetic material and a magnetic property of the magnetic material is improved as compared to a powder composite material without admixed fibers.

2. The magnetic material as claimed in claim 1, wherein
the powder composite material contains rare earth components.

3. The magnetic material as claimed in claim 1, wherein the fibers are magnetically inactive.

4. The magnetic material as claimed in claim 1, wherein the fibers are formed from at least one of a high-melting material, a high-modulus material and a high-strength material.

5. A method for producing a magnetic material, comprising the acts of:
providing a powder composite material sintered from at least one magnetizable alloy powder; and
admixing fibers into the powder composite material such that a magnet produced from admixed powder composite material and fibers has the fibers aligned in one direction.
